(19) United States
(12) Patent Application Publication
(10) Pub. No.: US 2007/0152013 A1
(43) Pub. Date: Jul. 5, 2007

(54) Nail gun back cover

(75) Inventors: Jack Wang, Taipei City (TW); T. K. Wu, Taipei City (TW); Ted Chou, Taipei City (TW)

Correspondence Address: HDSL, 4331 STEVENS BATTLE LANE, FAIRFAX, VA, 22033, US

(73) Assignee: Hao Cheng Technology Corp.

(21) Appl. No.: 11/325,379

(22) Filed: Jan. 5, 2006

(51) Int. Cl. B25C 1/04

(52) U.S. Cl. 227/130

(57) ABSTRACT

A nail gun back cover includes a back cover shell body made of magnesium alloy. The inner side of the shell body includes a first cylinder and a second cylinder surrounding the first cylinder extensively formed therein. A groove is formed between the first cylinder and the second cylinder. In addition, a valve mechanism is formed in the shell body. The valve mechanism includes a fixed valve securely connected to the first cylinder and a movable valve contained in the groove. The movable valve can move relative to the fixed valve so as to control the air flow. Furthermore, some elastic bodies are used to touch the end surfaces of the groove and the movable valve. Moreover, a fixed ring is securely fastened to the back cover, so as to limit the range of movement of the movable valve. In this manner, the overall weight of the nail gun is reduced, making the nail gun much easier to operate. In addition, the back cover shell body does not require additional mechanical processing, which can largely reduce the cost on processing and material.

### BACKGROUND OF THE INVENTION

The present invention relates generally to a nail gun back cover, and more particularly to a back cover of an air nail gun.

Since a nail gun can speed up works and easy to use, it has been used widely in internal decoration, conference site arrangement, or wooden constructions. However, long time operation of the nail gun can still induce muscular tiredness and pains, a light weighted nail gun is thus deemed necessary in the industry

Conventional back cover of a nail gun includes a back cover made of aluminum alloy, which includes a retaining space formed inside of the back cover. A ring-shaped sag groove is formed at the bottom portion of the retaining space. In addition, a movable valve is disposed in the retaining space. A trench is formed on the outer rim of the movable valve, so as to disposed washers therein. Furthermore, a spring is disposed contacting the movable valve and the ring- shaped sag groove. Therefore, a nail gun back cover is formed.

However, the conventional nail gun back cover has the following drawbacks. Since the back cover is made of aluminum alloy of large specific weight, the user will easily feel tired and muscular pains under long hours of operation. In addition, an air tightness is required between the retaining space of the back cover and the movable valve. Therefore, a back cover prototype model should be prepared and followed by cutting the inner surface of the prototype model using mechanical processing. In this way, the cost on additional processing and material is required. Further, the spring disposed between the back cover and the movable valve comprises a strong elastic restoration force. One needs to push very hard the back cover towards the nail gun body when assembling the nail gun. Meanwhile, a fastening operation is needed to securely combine the back cover with the nail gun body. Therefore, the assembly process is rather complicated.

Therefore, the inventor of the present invention has studied and developed possible solutions to the aforementioned drawbacks based on his many years of experience in the industry. Finally, a new nail gun back cover that can resolve the drawbacks described above is developed.

### BRIEF SUMMARY OF THE INVENTION

The present invention is to provide a nail gun back cover made of magnesium alloy of low specific weight, so as to reduce the overall weight of the nail gun, thereby making the nail gun much easier to operate. In addition, the back cover shell body does not require additional mechanical processing, which can largely reduce the cost on processing and material.

Accordingly, the nail gun back cover of the present invention includes a back cover shell body made of magnesium alloy. The inner side of the shell body includes a first cylinder and a second cylinder surrounding the first cylinder extensively formed therein. A groove is formed between the first cylinder and the second cylinder. In addition, a valve mechanism is formed in the shell body. The valve mechanism includes a fixed valve securely connected to the first cylinder and a movable valve contained in the groove. The movable valve can move relative to the fixed valve so as to control the air flow. Furthermore, some elastic bodies are used to touch the end surfaces of the groove and the movable valve. Moreover, a fixed ring is securely fastened to the back cover, so as to limit the range of movement of the movable valve.

### BRIEF DESCRIPTION OF THE DRAWINGS

FIG. 1 is an explosive view illustrating a nail gun back cover of the present invention.

FIG. 2 is an explosive view illustrating another viewing angle of the nail gun back cover of the present invention.

FIG. 3 is a perspective view of the nail gun back cover of the present invention before combining with a nail gun body.

FIG. 4 is a perspective view of the nail gun back cover of the present invention after combining with a nail gun body.

FIG. 5 is a sectional view illustrating a shooting operation of the nail gun.

FIG. 6 is a sectional view illustrating another shooting operation of the nail gun.

### DETAILED DESCRIPTION OF THE INVENTION

In order to better understanding the features and technical contents of the present invention, the present invention is hereinafter described in detail by incorporating with the accompanying drawings. However, the accompanying drawings are only for the convenience of illustration and description, no limitation is intended thereto.

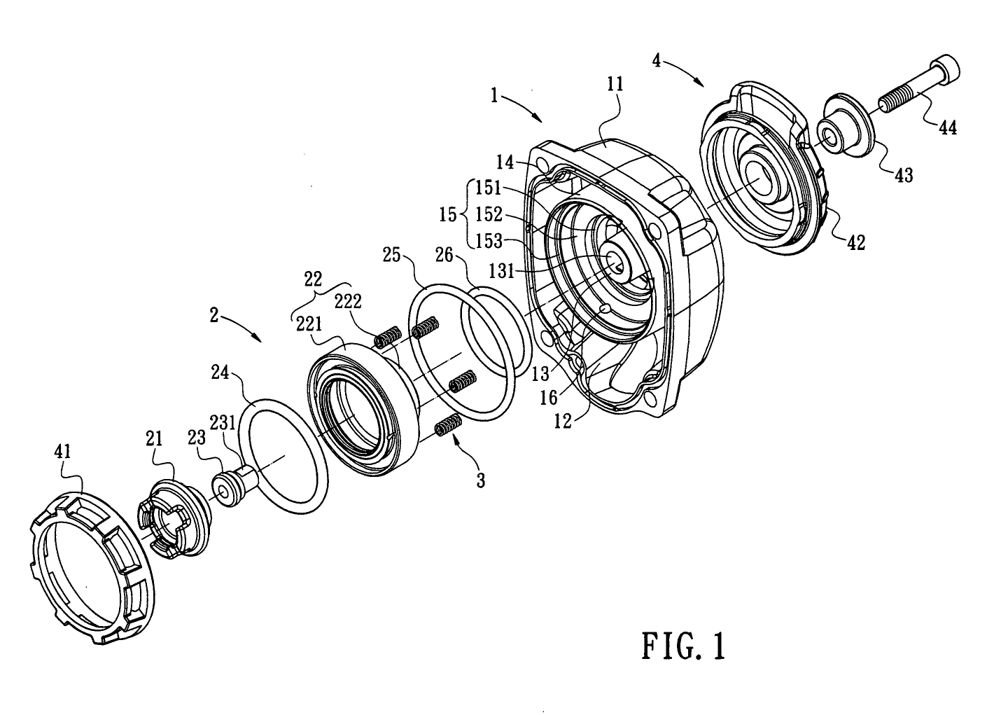

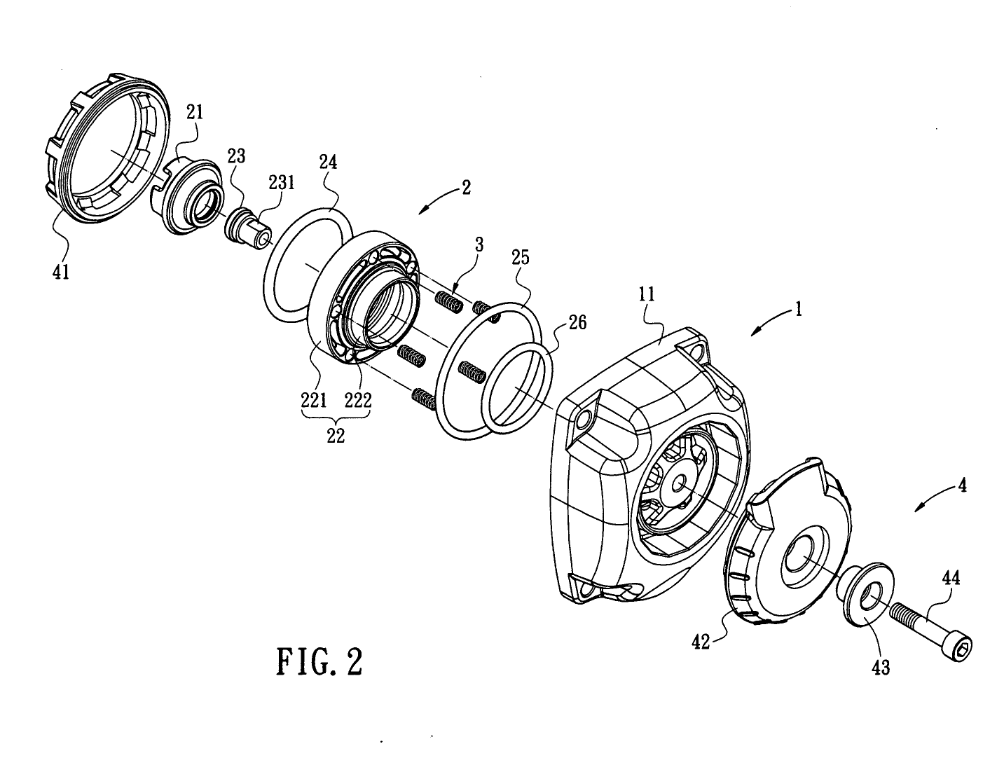

Referring to FIG. 1 and FIG. 2, an explosive view in accordance with different viewing angles of the nail gun back cover of the present invention is illustrated. As shown, the nail gun back cover includes a back cover 1, a valve mechanism 2, at least an elastic body 3 and a cover assembly 4.

The back cover 1 includes a shell body 11 made of magnesium alloy, which includes a retaining space 12 formed therein. A first cylinder 13 and a second cylinder 14 surrounding the first cylinder 13 are formed in the retaining space 12 extended from the center portion of the shell body 11. In addition, a groove 15 is formed between the first cylinder 13 and the second cylinder 14. The groove 15 is formed in a ladder shape, which includes a first ring surface 151 formed at the root portion, a second ring surface 152 formed at the central portion, and a third ring surface 153 formed around the rim portion. A ventilation hole 16 is formed on the second ring surface 152 below the second cylinder 14.

The valve mechanism 2 includes a fixed valve 21, a movable valve 22 and a connection element 23. The end surface of the fixed valve 21 contacts the end surface of the first cylinder 13. The fixed valve 21 is securely fastened to the first cylinder 13 via the connection element 23 penetrating through the fixed valve 21. A positioning portion 231 is formed at the outer side of the connection element 23. In this particular embodiment, the positioning portion 231 includes two parallel flat surfaces. An embedding groove 131 is formed at the inner portion of the first cylinder 13 corresponding the positioning portion 231, so as to prohibits the rotational motion between the connection element 23 and the first cylinder 13. The movable valve 22 is contained in the groove 15 making movable contact with the fixed valve 21, so as to control the air flow. The movable valve 22 includes a first ring 221 and a second ring 222 extended from the first ring 221. The outer radius of the second ring 222 is smaller than the outer radius of the first ring 221. A first washer 24 is disposed in the first ring 221, whereas a second washer 25 is disposed around the outer edge of the first washer 24 and on the third ring surface 153 of groove 15. In addition, a third washer 26 is disposed at the outer edge of the second ring 222 and the first ring surface 151 of the groove 15.

The elastic body 3 can be a spiral compressive spring of large radius or a plurality of spiral compressive springs of small radius. In this particular embodiment, the elastic body 3 is composed of four spiral compressive springs of smaller radius, which can better stabilize the movement of the movable valve 22. Two ends of the elastic body 3 touches the second ring surface 152 of the groove 15 and the outer surface of the first ring 221 of the movable valve 22.

The cover assembly 4 includes a fixed ring 41 securely fastened to the second cylinder 14, a fixed cover 42 securely fastened to the back face of the back cover 1, a guiding sleeve 43 penetrating the center of the fixed cover 42, and a bolt 44 that penetrates the guiding sleeve 43, the fixed cover and the first cylinder 13, and is screwed on the connection element 23 of the valve mechanism 2. The fixed ring 41 sandwiches the second washer 25 between its end surface and the third ring surface 153, so as to limit the range of motion of the movable valve 22.

By combining the parts described above, the overall weight of the nail gun is largely reduced, making the nail gun much easier to operate. In addition, the shell body 11 of the back cover 1 does not require another mechanical processing, which can largely reduce the cost on processing and material.

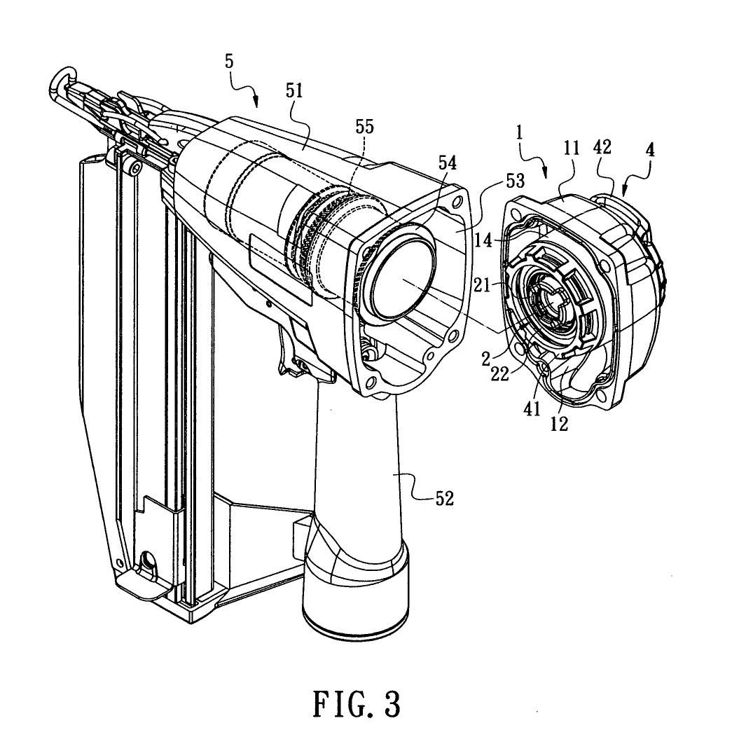

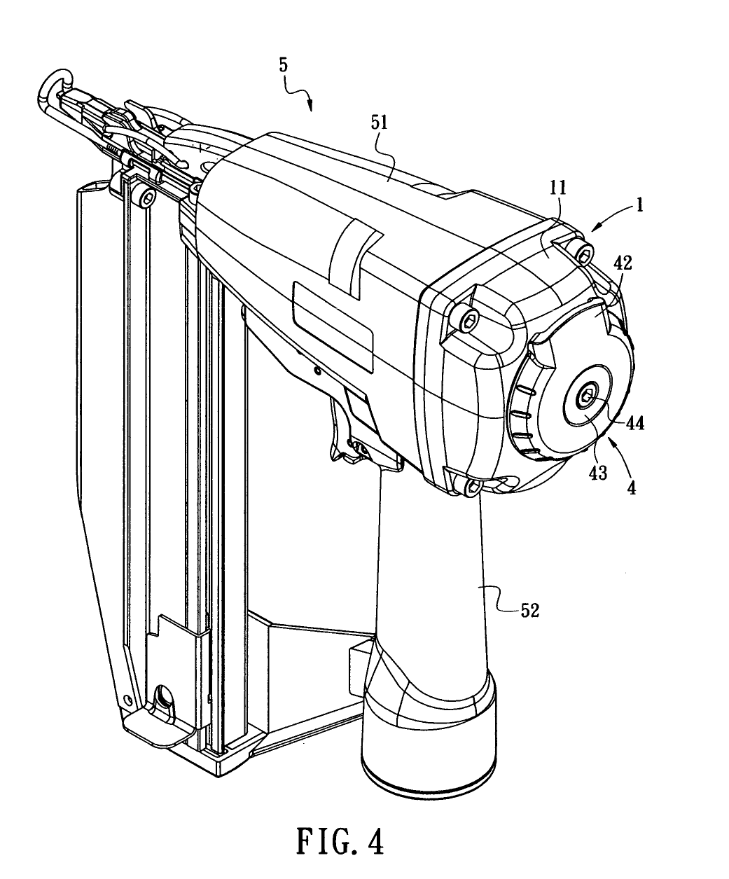

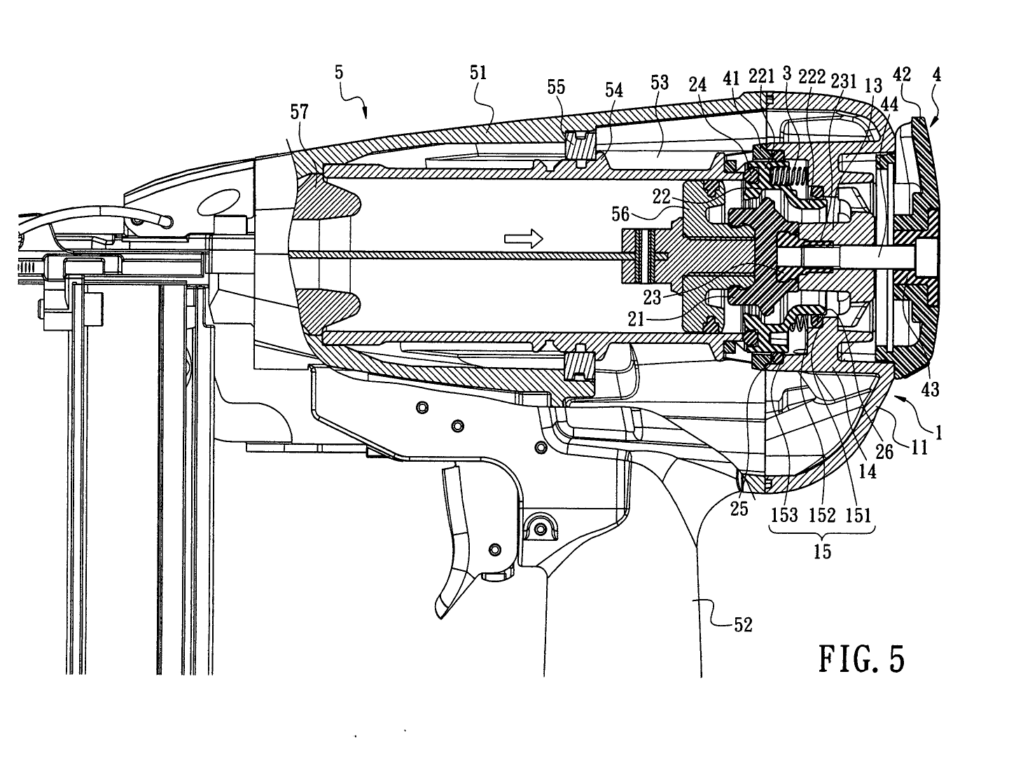

Referring to FIG. 3 and FIG. 4, a perspective view of the nail gun back cover of the present invention before and after combining with a nail gun body is illustrated, respectively. As shown, the nail gun back cover of the present invention can be securely fastened to a nail gun 5 via a plurality of screws. The nail gun 5 includes a nail gun body 51, which is connected to a handle 52 extended from bottom portion of the nail gun body 51. A hollow space 53 is formed inside of the nail gun body 51, which contains a chamber 54 therein. A gasket 55 is connected between the chamber 54 and the nail gun body 51. A striker 56 (shown in FIG. 5) is disposed in the chamber 54, which can reciprocate relative to the chamber 54. In addition, a buffer pad 57 is securely fastened to the root portion of the hollow space 53 corresponding the end surface of the striker 56.

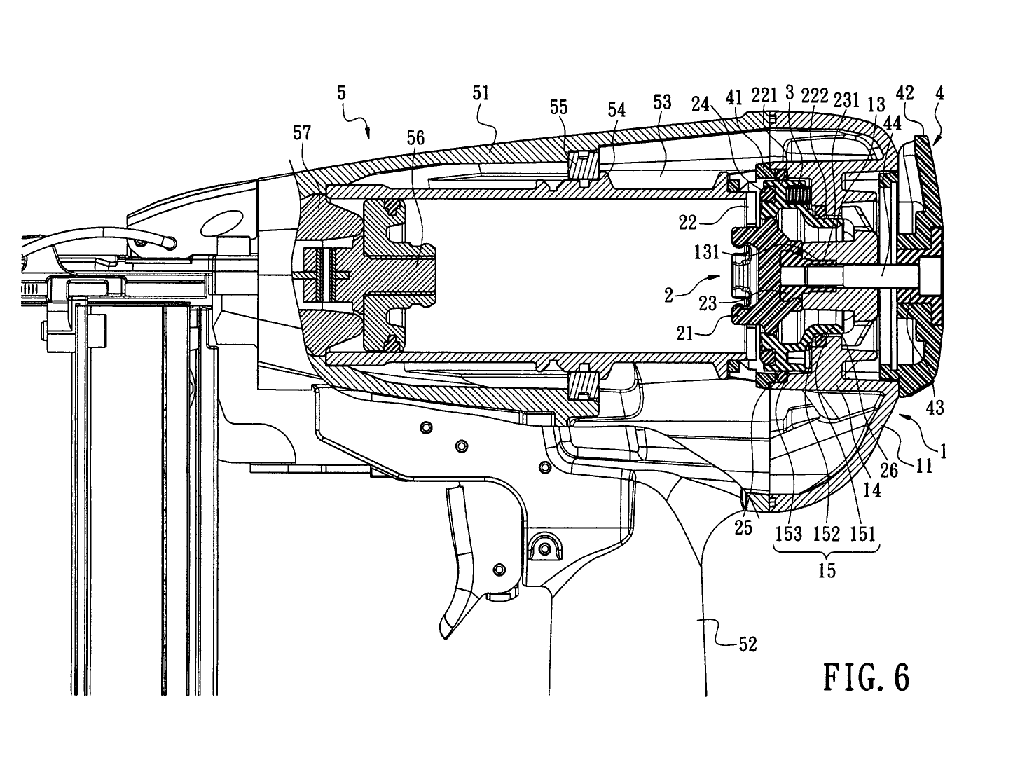

Referring to FIG. 5 and FIG. 6, a sectional view of a shooting operation of the nail gun is illustrated. When using the nail gun, some air is guided into the nail gun so as to control the fixed valve 21 and the movable valve 22 of the valve mechanism 2. When the first washer 24 of the movable valve 22 touches the outer surface of the chamber, as shown in FIG. 6, the valve is open. Therefore, the striker 55 can move in the chamber to complete a shooting operation.

In summary, the nail gun back cover of the present invention can indeed achieve the functions described above and at the same time satisfy the patentability requirement of the patent law, a grant of letters patent is thus respectfully requested.

Since, any person having ordinary skill in the art may readily find various equivalent alterations or modifications in light of the features as disclosed above, it is appreciated that the scope of the present invention is defined in the following claims. Therefore, all such equivalent alterations or modifications without departing from the subject matter as set forth in the following claims is considered within the spirit and scope of the present invention.

What is claimed is:

1. A nail gun back cover, which comprises:
a back cover including a shell body made of magnesium alloy, the inner side of the shell body comprising a first cylinder and a second cylinder surrounding the first cylinder, the first cylinder and the second cylinder having a groove formed therebetween;
a valve mechanism, which comprises a fixed valve securely connected to the first cylinder and a movable valve contained in the groove, wherein the movable valve moves relative to the fixed valve so as to control the air flow;
at least an elastic body, the two ends of which touches the end surfaces of the groove and the movable valve; and
a cover assembly having a fixed ring securely fastened to the second cylinder and a fixed cover securely fastened to the back face of the back cover, whereby the fixed ring limits the range of movement of the movable valve.

2. The nail gun back cover as recited in claim 1, wherein the groove of the back cover is in ladder shape, which includes a first ring surface at the root portion, a second ring surface at the central portion, and a third ring surface around the rim portion.

3. The nail gun back cover as recited in claim 2, wherein the movable valve includes a first ring and a second ring extended from the end surface of the first ring, a second washer being disposed on the outer rim of the first ring and the third ring surface of the groove, a third washer being disposed around the outer rim of the second ring and the first ring surface of the groove.

4. The nail gun back cover as recited in claim 1, wherein the valve mechanism further comprises a connection element, which is penetratively disposed on the fixed valve, thereby securely fastening the fixed valve to the first cylinder.

5. The nail gun back cover as recited in claim 4, wherein a positioning portion is formed at the outer side of the connection element, and an embedding groove is formed on the first cylinder corresponding the positioning portion, thereby prohibits the relative motion between the connection element and the first cylinder.

6. The nail gun back cover as recited in claim 1, wherein the elastic body comprises a plurality of springs.

7. The nail gun back cover as recited in claim 1, wherein the cover assembly further comprises a guiding sleeve penetrating the center of the fixed cover, and a threaded bolt penetrating the guiding sleeve, the fixed cover and the first cylinder, the threaded bolt being fastened to the valve mechanism.
